(19) United States
(12) Patent Application Publication
(10) Pub. No.: US 2025/0083340 A1
(43) Pub. Date: Mar. 13, 2025

(54) INDUSTRIAL ROBOT COMPRISING SEALED COVER

(71) Applicant: ABB Schweiz AG, Baden (CH)

(72) Inventors: Tomas Botold, Västerås (SE); Shanghua Li, Västerås (SE)

(21) Appl. No.: 18/717,152

(22) PCT Filed: Dec. 13, 2021
(86) PCT No.: PCT/EP2021/085418

§ 371 Date: Jun. 6, 2024

(51) Int. Cl. B25J 19/00; F16J 15/10

(52) U.S. Cl. CPC B25J 19/0075; F16J 15/104

(57) ABSTRACT

An industrial robot including a base structure having an opening; a cover configured to fit in the opening; and an external seal bridging a gap between the base structure and the cover when the cover is fitted in the opening. The external seal forms within the gap a closed path entirely visible from a single perspective.

### TECHNICAL FIELD

The present disclosure generally relates to industrial robots. In particular, an industrial robot comprising a cover and an external seal for sealing the cover in an opening is provided.

### BACKGROUND

In some processing environments, it is desirable to maintain a high level of hygiene. Examples of such processing environments include environments where food, beverages or pharmaceuticals are handled by an industrial robot. Any sanitary problem in such processing environment might result in severe consequences. For this reason, comprehensive cleaning of the robot and its surroundings is often performed on a daily basis. Typical cleaning procedures include high pressure washing with hot water containing chemical agents, such as strong acidic or alkaline detergents and disinfectants.

An industrial robot typically comprises seals between its moving parts to prevent media from an external region with respect to the robot to enter an internal region of the robot, and vice versa. When water reaches the internal region, corrosion is accelerated and contaminants can be carried by the water to the internal region. Detection of such leakage into the internal region of the robot is difficult and may therefore progress for long time periods without being noticed. Leakage of gearboxes is also a common issue occurring in industrial robots. When the sealing solution is insufficient, a food grade lubricant might be contaminated in the internal region and pass through the seal to the external region.

US2019193262 A1 discloses a hermetically sealed articulated arm apparatus comprising a first arm segment, a second arm segment and an intermediate elbow joint. The elbow joint comprises an elbow housing and an elbow cap. A static seal member includes an O-ring seal that is placed in an externally accessible channel formed within a portion of the elbow cap and a portion of the elbow housing.

Since the seal member in US2019193262 A1 encloses the elbow housing, access to the seal member may have to take place from several different directions around the elbow housing, for example to investigate a health status and to clean the seal member. In any case, access to the seal member is complicated. Moreover, since the seal member surrounds the elbow housing, there is an increased risk that the articulated arm apparatus is stopped in a position where a part of the seal member is difficult to access.

WO 2021223049 A1 discloses a robot comprising a ring-shaped housing, a flange and a sealing ring.

WO 9903653 A1 discloses a shielded industrial robot comprising a covering element, bolts and washers. The covering element is fixed by the bolts via washers.

US2020370652 A1 discloses a robot comprising a fifth arm member, a sixth arm member rotatable relative to the fifth arm member, and a seal member.

US2021178611 A1 discloses an articulated robot comprising a housing body having an opening, a cover for closing the opening, and an endless gasket interposed between the housing body and the cover.

### SUMMARY

One object of the invention is to provide an improved industrial robot comprising an external seal configured to seal between a base structure and a cover when the cover is fitted in an opening.

This object is achieved by the industrial robot according to appended claim 1.

The invention is based on the realization that when the entire external part of the external seal can be viewed from a single point, health inspection, cleaning and/or maintenance of the external seal can be made more efficient.

According to the invention, there is provided an industrial robot comprising a base structure having an opening; a cover configured to fit in the opening; and an external seal bridging a gap between the base structure and the cover when the cover is fitted in the opening. The external seal forms within the gap a closed path entirely visible from a single perspective.

The industrial robot enables an improved access to the external seal. For example, a health status of the external seal can be more efficiently controlled, either manually or by machine vision. It can thereby more easily be ensured that the external seal performs as intended.

Furthermore, a cleaning of the external seal can be made more efficient, especially if performing a dedicated cleaning operation of the external seal that differs from other parts of the industrial robot. This contributes to a more efficient cleaning and a higher level of cleanliness.

The external seal reliably ensures that water and washdown chemicals do not enter the opening from an external region of the industrial robot, and that any oil or compressed air inside the opening in an internal region of the industrial robot do not reach the external region. The industrial robot therefore has a very hygienic design.

The cover is stationary with respect to the base structure when the cover is fitted in the opening. The external seal is thus a static seal.

The external seal encloses the cover and the gap separates the cover from the base structure. In this way, any external direct contact between the cover and the base structure can be avoided. In many prior art industrial robots, covers are designed with metal to metal contact externally. This is not wanted on hygienic industrial robots due to the growth risk of bacteria in this area.

By removing the cover, the internal region can be accessed through the opening for performing various tasks. Examples of such tasks comprise connecting electric connectors, tightening a cable harness, accessing an oil plug, accessing a motor or a gearbox for maintenance, and status monitoring of components. The cover may thus be a service cover.

The cover and the opening may have corresponding shapes. The cover and the opening may for example be round, such as oval or circular.

Each of the base structure and the cover may be made of metal, such as titanium, aluminium or stainless steel, for example AISI 316 or AISI 316L stainless steels.

Each of the base structure and the cover may be an integral body, i.e. formed from a single piece of material. The base structure and the cover may be rigid. Each of the base structure and the cover may be made of metal, such as titanium, aluminium or stainless steel, for example AISI 316 or AISI 316L stainless steels.

The external seal may be made of rubber. Examples of suitable rubbers comprise M-Class rubbers under the ASTM standard D-1418, such as EPDM (ethylene propylene diene monomer) rubber. Alternatively, or in addition, the external seal may be made of a food grade material, such as an FDA (Food and Drug Administration) compliant material, i.e. a material that meets all of the FDA's guidelines for safe, direct contact with food. According to one variant, the external seal meets the IEC (International Electrotechnical Commission) standard 60529 and/or the IP69K rating according to the German standard DIN 40050-9.

Throughout the present disclosure, the cover is a lid. The base structure may be constituted by, or form a part of, a housing of the industrial robot.

The external seal may be compressed between the base structure and the cover when the cover is fitted in the opening. In this way, the sealing is further improved.

The base structure may comprise a base external surface and the cover may comprise a cover external surface. In this case, the base external surface and the cover external surface may be substantially flush with each other, or flush with each other, immediately adjacent to the external seal when the cover is fitted in the opening. In this way, there is a reduced risk that contaminants are accumulated in the region of the external seal and the cleaning of the industrial robot can be improved.

Each of the base external surface and the cover external surface face the external region of the industrial robot. The base external surface and/or the cover external surface may be flat or curved, such as convex.

The external seal may comprise a seal external surface that is substantially flush with, or flush with, the base external surface and the cover external surface when the cover is fitted in the opening. In this way, the external seal makes sure that there is no unsealed gap between the base external surface and the cover external surface. The hygienic design is thereby further improved.

The seal external surface may face the external region of the industrial robot. The seal external surface may be flat or curved, such as convex.

The external seal may have a shape of a truncated cone, or similar to a truncated cone. In any case, an imaginary apex of the truncated cone may be positioned in the internal region. Thus, the external seal may be wider at the seal external surface. An external circumference of the external seal may be larger at the seal external surface than behind (i.e. further towards the internal region) the seal external surface. Alternatively, or in addition, an internal circumference of the external seal may be larger at the seal external surface than behind the seal external surface. In these ways, the shape of the external seal promotes compression to provide both a tight seal and a hygienic design.

The opening may define a depth direction. The opening may have a constant cross-sectional profile along at least a part of the depth direction. The opening may for example define a central axis coinciding with the depth direction. The central axis may for example be defined by a geometrical center point of the opening.

The cover external surface may be substantially transverse to, or transverse to, the depth direction when the cover is fitted in the opening. Alternatively, or in addition, the base external surface may be substantially transverse to, or transverse to, the depth direction.

The external seal may be compressed in a direction parallel with the depth direction when the cover is fitted in the opening. The external seal may for example be compressed in an axial direction with respect to the central axis when the external seal is fitted in the opening.

The external seal may be compressed in a direction transverse to the depth direction when the cover is fitted in the opening. The external seal may for example be compressed in a radial direction with respect to the central axis of the opening.

The cover may comprise a cover groove for receiving the external seal. The cover groove may be curved and/or concave. The cover groove may face in a direction away from a position of the cover external surface. The cover groove may additionally face away from the central axis. In case the cover is flat, the cover groove may lie in a plane parallel with the cover external surface.

The base structure may comprise a base groove for receiving the external seal. The base groove may be curved and/or concave. The base groove may face in a direction towards a position of the cover external surface when the cover is fitted in the opening. The base groove may additionally face towards the central axis. In case the base external surface is flat, the base groove may lie in a plane parallel with the base external surface. The base groove may face the cover groove.

The industrial robot may further comprise a secondary seal configured to seal between the base structure and the cover when the cover is fitted in the opening. The secondary seal may be positioned between the central axis and the external seal. The secondary seal functions as a backup seal. The secondary seal may or may not be a food grade seal. The secondary seal may be compressed in a direction transverse to the depth direction when the cover is fitted in the opening, such as in a radial direction with respect to the central axis.

The cover may comprise a secondary groove, and the secondary seal may be seated in the secondary groove. The secondary groove may face away from the central axis.

The cover may comprise a collar. The secondary groove may be provided in the collar. The collar may protrude in a direction away from the cover external surface and towards the internal region. The collar may be positioned between the central axis and the external seal. The secondary seal may enclose the entire collar.

The industrial robot may further comprise a fastener configured to secure the cover to the base structure when the cover is fitted in the opening. The fastener may be positioned inside the external seal, such as between the secondary seal and the external seal or inside the secondary seal. The industrial robot may comprise one or several such fasteners.

The fastener may be a threaded fastener for passing through a through hole in the cover and threadingly engaging the base structure. Examples of threaded fasteners comprise screws and bolts.

The industrial robot may further comprise a washer configured to be positioned between the fastener and the cover. The washer may be made of vulcanized rubber, or may comprise vulcanized rubber, for example on a radially external side.

The fastener may comprise a head. In this case, the head may overlap the washer.

The industrial robot may comprise a plurality of links interconnected by a plurality of joints. The base structure may be fixed to one of the links.

### BRIEF DESCRIPTION OF THE DRAWINGS

Further details, advantages and aspects of the present disclosure will become apparent from the following description taken in conjunction with the drawings, wherein:

FIG. 1: schematically represents a side view of an industrial robot;

FIG. 2: schematically represents an enlarged view of region A in FIG. 1;

FIG. 3: schematically represents a cross-sectional view along line B-B in FIG. 2; and

FIG. 4: schematically represents an enlarged view of region C in FIG. 3.

### DETAILED DESCRIPTION

In the following, an industrial robot comprising a cover and an external seal for sealing the cover in an opening, will be described. The same or similar reference numerals will be used to denote the same or similar structural features.

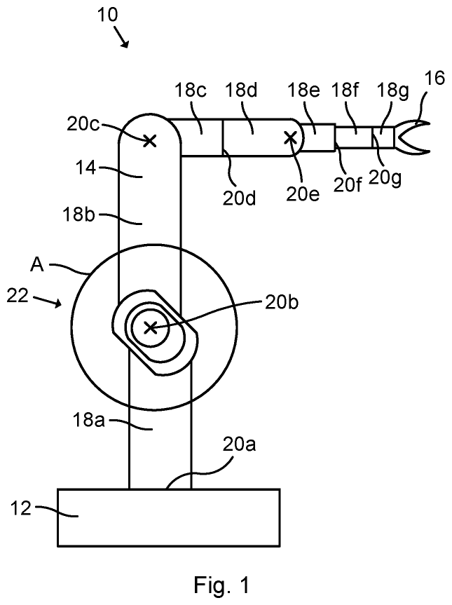

FIG. 1 schematically represents a side view of an industrial robot 10. The industrial robot 10 is exemplified as a seven axis industrial robot but the present disclosure is not limited to this type of robot. An industrial robot according to the present disclosure may comprise at least three axes.

The industrial robot 10 of this example comprises a base member 12, a manipulator 14 movable relative to the base member 12, and an end effector 16 at a distal end of the manipulator 14. The manipulator 14 of this specific example comprises a first link 18a distal of the base member 12 and rotatable around a vertical axis relative to the base member 12 at a first joint 20a, a second link 18b distal of the first link 18a and rotatable around a horizontal axis relative to the first link 18a at a second joint 20b, a third link 18c distal of the second link 18b and rotatable around a horizontal axis relative to the second link 18b at a third joint 20c, a fourth link 18d distal of the third link 18c and rotatable relative to the third link 18c at a fourth joint 20d, a fifth link 18e distal of the fourth link 18d and rotatable relative to the fourth link 18d at a fifth joint 20e, a sixth link 18f distal of the fifth link 18e and translationally movable relative to the fifth link 18e at a sixth joint 20f, and a seventh link 18g distal of the sixth link 18f and rotatable relative to the sixth link 18f at a seventh joint 20g. The seventh link 18g comprises an interface (not denoted) to which the end effector 16 is attached. The industrial robot 10 comprises an electric motor and a gearbox (not shown) for driving each joint 20a-20g.

The industrial robot 10 further comprises a cover assembly 22. The cover assembly 22 is here provided at the second joint 20b. A cover assembly 22 may be provided at one, several or all of the joints 20a-20g, and/or on any of the links 18a-18g. The industrial robot 10 is a hygienic robot. The exterior of the industrial robot 10 is sealed. An internal region of the industrial robot 10 may be ventilated through the base member 12.

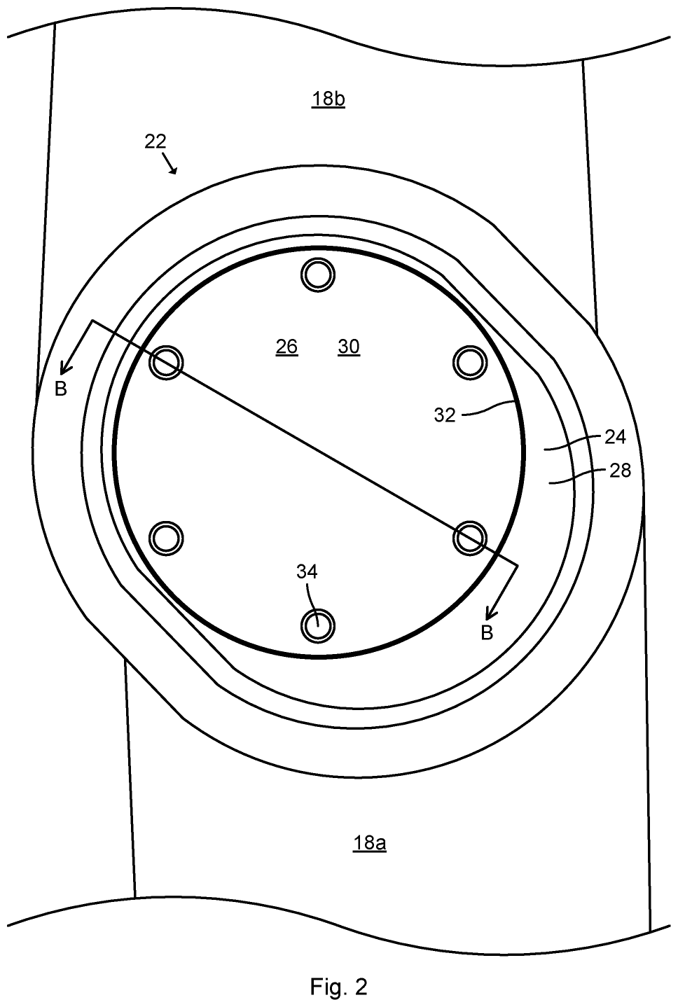

FIG. 2 schematically represents an enlarged view of region A in FIG. 1. In FIG. 2, the cover assembly 22 can be seen in greater detail. The cover assembly 22 comprises a base structure 24 and a cover 26. In this specific example, the base structure 24 forms a part of a housing of the first link 18a. The base structure 24 and the first link 18a thus always move in common. The base structure 24 comprises a base external surface 28.

The cover 26 is here exemplified as a circular and flat lid. The cover 26 comprises a cover external surface 30.

As shown in FIG. 2, the cover assembly 22 further comprises an external seal 32. The external seal 32 bridges a gap between the base structure 24 and the cover 26. The external seal 32 is circular and entirely encloses the cover 26. The base external surface 28 and the cover external surface 30 are therefore not in direct contact. As can be seen in FIG. 2, the external seal 32 forms a closed path in the gap between the base structure 24 and the cover 26. In this example, the path is circular. The entire path is visible from a single point of view, such as in the view in FIG. 2. The external seal 32 can therefore easily be accessed for visual inspection and/or cleaning. Any failure of the external seal 32 can for example be detected more easily.

The cover assembly 22 further comprises a plurality of fasteners, here exemplified as bolts 34. In this specific example, the cover assembly 22 comprises six bolts 34 evenly distributed around the cover 26. The bolts 34 fix the cover 26 to the base structure 24.

The cover 26 can be manually removed from the industrial robot 10, in this example by removing the bolts 34. Once the cover 26 has been removed, the interior of the industrial robot 10, here the interior of the second joint 20b, can be accessed. In this way, a technician can for example access the motor and the gearbox associated with the second joint 20b.

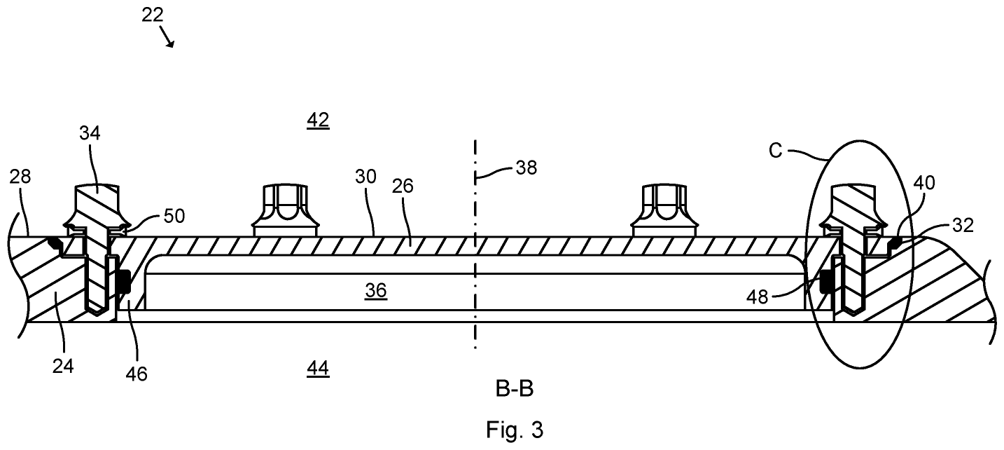

FIG. 3 schematically represents a cross-sectional view along line B-B in FIG. 2. As shown, the base structure 24 comprises an opening 36. The cover 26 is fitted in the opening 36 when secured to the base structure 24 by the bolts 34. The opening 36 of this example is circular and defines a central axis 38 perpendicular to the base external surface 28. The central axis 38 coincides with a depth direction of the opening 36.

The base external surface 28 is flat immediately adjacent to the external seal 32. As shown in FIG. 3, the base external surface 28 and the cover external surface 30 are flush, i.e. lie in a common plane. As a consequence, a risk of contaminants collecting in the region of the external seal 32 is reduced. Moreover, cleaning of the cover assembly 22, for example by spraying hot pressurized water containing chemical agents thereon, is made more efficient.

As shown in FIG. 3, each of the base structure 24 and the cover 26 is integrally formed from a single piece of material. Each of the base structure 24 and the cover 26 may for example be made of AISI 316 stainless steel. In this example, each of the base external surface 28 and the cover external surface 30 has a surface roughness profile, where an arithmetic mean deviation of the roughness profile, Ra, is less than 0.8 μm.

The external seal 32 comprises a seal external surface 40. Also the seal external surface 40 is flat and flush with the base external surface 28 and the cover external surface 30 in this example. The external seal 32 may for example be made of a food grade EPDM (ethylene propylene diene monomer) rubber.

FIG. 3 further shows an external region 42 and an internal region 44 with respect to the cover 26. The external region 42 is outside of the manipulator 14 and the internal region 44 is inside the manipulator 14. The external seal 32 reliably prevents that, for example, washdown medium travels from the external region 42 to the internal region 44. Conversely, the external seal 32 also reliably prevents that, for example, lubricants or pressurized air travel from the internal region 44 to the external region 42. Each of the base external surface 28, the cover external surface 30 and the seal external surface 40 face the external region 42.

The cover 26 of this example comprises a cylindrical collar 46. The collar 46 protrudes into the internal region 44. The collar 46 is positioned between the central axis 38 and the external seal 32.

The cover assembly 22 of this example further comprises a secondary seal 48. The secondary seal 48 is here provided in the collar 46. The secondary seal 48 is configured to seal between the base structure 24 and the cover 26 and functions as a backup seal. The secondary seal 48 here encloses the entire collar 46. In FIG. 3, the secondary seal 48 is compressed in a radial direction with respect to the central axis 38. The secondary seal 48 is here provided radially inward of the external seal 32 with respect to the central axis 38.

In this example, the bolts 34 are positioned between the external seal 32 and the secondary seal 48. One, several or all of the bolts 34 may alternatively be positioned between the secondary seal 48 and the central axis 38.

As shown in FIG. 3, the cover assembly 22 of this example further comprises a washer 50 associated with each bolt 34. Both the bolts 34 and the washers 50 have a hygienic design.

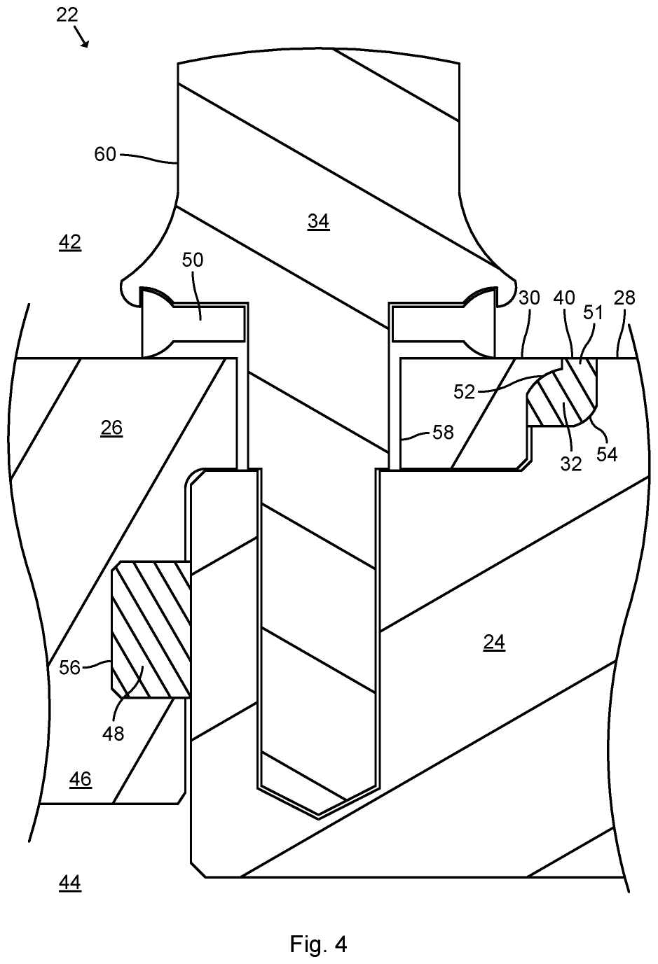

FIG. 4 schematically represents an enlarged view of region C in FIG. 3. In FIG. 4, the gap 51 between the base structure 24 and the cover 26, that is bridged by the external seal 32, can be seen more clearly. The cover 26 comprises a cover groove 52 extending around the cover 26. The cover groove 52 of this example is concave and faces away from a position of the cover external surface 30 and away from the central axis 38.

The base structure 24 comprises a base groove 54 extending around the opening 36. The base groove 54 of this example is concave and faces towards a position of the cover external surface 30, towards the central axis 38 and towards the cover groove 52.

FIG. 4 further shows that the external seal 32, when compressed, has a shape resembling a truncated cone. An external circumference of the external seal 32 is larger at the seal external surface 40 than below (in FIG. 4) the seal external surface 40. Moreover, an internal circumference of the external seal 32 is larger at the seal external surface 40 than below the seal external surface 40.

As shown in FIG. 4, the external seal 32 is received in both the cover groove 52 and the base groove 54. Due to the shapes and orientations of the external seal 32, the cover groove 52 and the base groove 54, the external seal 32 is compressed in both an axial direction and a radial direction with respect to the central axis 38 when the cover 26 is secured to the base structure 24. These properties of the external seal 32, the cover groove 52 and the base groove 54 have proven to provide a very hygienic performance of the industrial robot 10.

FIG. 4 further shows that the collar 46 comprises a secondary groove 56 facing away from the central axis 38. The secondary seal 48 is received in the secondary groove 56.

FIG. 4 further shows one of several through holes 58 provided in the cover 26. Each bolt 34 passes through an associated through hole 58 and is threadingly engaged with the base structure 24.

FIG. 4 further shows that a head 60 of the bolt 34 overlaps the washer 50. The head 60 is thus wider than the washer 50. In this example, also each head 60 of the bolts 34 has a surface roughness profile, where an arithmetic mean deviation of the roughness profile, Ra, is less than 0.8 μm. The radially outer surface of each washer 50 comprises vulcanized rubber. Also these properties contribute to the hygienic design of the industrial robot 10.

In order to mount the cover 26, the external seal 32 may initially be seated either in the cover groove 52 or in the base groove 54. If the external seal 32 is initially seated in the cover groove 52, the cover 26 with the external seal 32 thereon is moved into the opening 36. The bolts 34 are then inserted and tightened such that the external seal 32 is compressed. The procedure may be reversed to remove the lid. The industrial robot 10 provides a hygienic static seal design for the cover 26 with improved accessibility.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. An industrial robot comprising:
a base structure having an opening;
a lid configured to fit in the opening; and
a static external seal bridging a gap between the base structure and the lid when the lid is fitted in the opening;
characterized in that the external seal forms within the gap a closed path entirely visible from a single perspective.

2. The industrial robot according to claim 1, wherein the base structure comprises a base external surface, wherein the lid includes a cover external surface, and wherein the base external surface and the cover external surface are substantially flush with each other immediately adjacent to the external seal when the lid is fitted in the opening.

3. The industrial robot according to claim 2, wherein the external seal comprises a seal external surface that is substantially flush with the base external surface and the lid external surface when the cover is fitted in the opening.

4. The industrial robot according to claim 1, wherein the opening defines a depth direction.

5. The industrial robot according to claim 4, wherein the lid external surface is substantially transverse to the depth direction when the lid is fitted in the opening.

6. The industrial robot according to claim 4, wherein the external seal is compressed in a direction parallel with the depth direction when the lid is fitted in the opening.

7. The industrial robot according to claim 4, wherein the external seal is compressed in a direction transverse to the depth direction when the lid is fitted in the opening.

8. The industrial robot according to claim 1, wherein the lid comprises a cover groove for receiving the external seal.

9. The industrial robot according to claim 8, wherein the cover groove faces in a direction away from a position of the cover external surface.

10. The industrial robot according to claim 1, wherein the base structure comprises a base groove for receiving the external seal.

11. The industrial robot according to claim 1, further comprising a secondary seal configured to seal between the base structure and the cover when the cover is fitted in the opening.

12. The industrial robot according to claim 11, wherein the secondary seal is compressed in a direction transverse to the depth direction when the lid is fitted in the opening.

13. The industrial robot according to claim 11, wherein the lid comprises a secondary groove, and wherein the secondary seal is seated in the secondary groove.

14. The industrial robot according to claim 1, wherein the industrial robot comprises a plurality of links interconnected by a plurality of joints, and wherein the base structure is fixed to one of the links.

15. (canceled)

16. The industrial robot according to claim 10, wherein the base groove faces in a direction towards a position of the cover external surface when the lid is fitted in the opening.

17. The industrial robot according to claim 2, wherein the opening defines a depth direction.

18. The industrial robot according to claim 2, wherein the base structure comprises a base groove for receiving the external seal.

19. The industrial robot according to claim 5, wherein the external seal is compressed in a direction parallel with the depth direction when the lid is fitted in the opening.

20. The industrial robot according to claim 5, wherein the external seal is compressed in a direction transverse to the depth direction when the lid is fitted in the opening.
